(19) United States
(12) Patent Application Publication
(10) Pub. No.: US 2004/0116138 A1
(43) Pub. Date: Jun. 17, 2004

(54) System and method for communication recovery following service interruptions

(76) Inventors: Steven Lloyd Greenspan, Scotch Plains, NJ (US); William Colyer Hill, Montville, NJ (US)

Correspondence Address: AT&T CORP., P.O. BOX 4110, MIDDLETOWN, NJ, 07748, US

(21) Appl. No.: 10/316,677

(22) Filed: Dec. 11, 2002

(51) Int. Cl. H04Q 7/20; H04B 7/005; H04B 7/01; H04B 7/015; H04B 15/00

(52) U.S. Cl. 455/501; 455/423

(57) ABSTRACT

A system and method for communication recovery following service interruptions is disclosed wherein parties to communication which has experienced a service interruption are provided the opportunity to record messages for one another during the service interruption so that the messages can be provided to the parties when communication is later re-established.

### CROSS REFERENCE TO RELATED APPLICATIONS

N/A

### BACKGROUND OF THE INVENTION

The present invention relates to systems and methods for communication recovery following service interruptions and more particularly to systems and methods for enabling continued communication during service interruptions.

The quality and continuity of wireless service coverage varies greatly between different geographic locations. In a wireless telecommunication system, such as a cellular telephone system, telephone calls are dropped more often than in a conventional wired or wireline system. There are a number of reasons why a telephone call with a wireless telephone may be dropped or lost. One reason for dropped calls is that the wireless telephone has left the coverage area of the wireless system. As is well known, cellular telephone systems are divided into cells, each of which is served by a base station which communicates with wireless telephones (i.e., mobile telephones) located within the cell. The conglomeration of all the cells together make up the coverage area of a certain cellular system/service provider. If a mobile telephone travels outside the coverage area, the wireless communication channel between the mobile telephone and the wireless system will be lost and the call will be dropped. In some situations the mobile telephone may be entering the coverage area of another cellular service provider. In such a case, the call may continue only if the mobile telephone has roaming privileges in that other cellular system.

Another reason that an established call may be dropped in a cellular system is due to handoff. As is well known, when a mobile telephone travels from one cell to another cell, the call is handed off from the base station serving the one cell to the base station serving the other cell. In some situations the base station serving the other cell may not have any radio channels available for communication with the mobile telephone at the time of the handoff. In such a situation the established call with the mobile telephone will be dropped. Another reason for dropped calls in a cellular system is coverage holes or gaps, which are areas in the geographic serving area which do not receive signals from the system for some reason. Such coverage holes or gaps include both indoor and outdoor areas. If a mobile telephone enters a coverage hole where coverage is not available, radio communication with the serving base station will be lost and the call will be dropped. Calls in a cellular system may also be dropped due to RF interference, equipment failures and other environmental/structural obstacles which may impede signal establishment within the network.

Whether the wireless device is a telephone, laptop, palmtop or other device, the popularity of these devices is ever increasing. However, as the demand for these devices has exponentially increased, the quality of performance of many of these devices has somewhat suffered. This phenomenon is especially evident with respect to wireless telephones where one telephone from one service provider may have a completely different quality of reception than a telephone from another service provider in the same exact physical location. The brochures and information provided by wireless service providers thus only give general maps and locations as to their “reach” or coverage of service. However, as most people, especially those who commute back and forth between two fixed locations every day and those who may travel in the same general areas, it would be helpful to know beforehand, which service providers offer the best service in those predefined areas. For example, in large cities, reception quality can vary greatly due to the great amount of interference in those areas. However, if an individual works in a certain high-rise building and wants to find out which wireless service provider would be best for them, there is no real definitive source as to this information aside from casual word of mouth.

Typical methods for determining where to place wireless towers/antennas involve both theoretical computerized estimations and some degree of on-site measurements for reception quality. Realistically, it is impossible or otherwise extremely difficult to test every location since reception may vary due to factors which may not be present during on-site measurement such as traffic patterns, weather and other interfering factors which may affect reception on a given day, time and place.

Accordingly, in view of the fact that dropped or disconnected calls are inevitable especially in a wireless context, it would be extremely desirable to be able to recover communications or at least enable some form of communications during these service interruptions.

### SUMMARY OF THE INVENTION

The present invention is a system and method for providing for communication recovery following service interruptions. Generally, parties in a communication which has experienced some type of service interruption are provided the opportunity to record one or more messages in order to recover or preserve the previously established communications. The message (2) are subsequently played back for the other party or parties in the communication. In one embodiment, the present invention is a method for determining if a communication has been prematurely terminated between at least two parties, recovering at least a portion of the communication if the communication has been prematurely terminated and re-establishing the prematurely terminated communication utilizing at least the recovered portion of the communication.

In yet another embodiment, the present invention is a method for recovering communications during service interruptions comprising receiving a message from at least one party to a communication experiencing a service interruption, recording the received message and providing the message to at least one other party which experienced the service interruption.

In yet still another embodiment, the present invention is a method comprising determining when a service interruption has occurred, recording messages from users during service interruptions, re-establishing communications between the users and playing back the messages received during service interruptions.

### BRIEF DESCRIPTION OF THE DRAWINGS

FIG. 1 illustrates an exemplary system of the present invention.

FIG. 2 illustrates an exemplary method of the present invention.

FIG. 3 illustrates another exemplary method of the present invention.

FIG. 4 illustrates an exemplary operative scenario of the present invention.

### DETAILED DESCRIPTION OF THE INVENTION

The present invention relates to systems and methods for providing for communication recovery during service interruptions. As discussed earlier herein such service interruptions typically involve the unwanted cessation of temporal communications which commonly occurs, for example, during wireless communications. Service interruptions may occur for a variety of reasons such as signal interference, out of range communications, weather factors, other environmental factors, etc. For exemplary purposes, the details of the invention will be discussed with respect to a wireless communication environment but the teachings herein are applicable to service interruptions such as may occur over a variety of communication forms, media and protocols such as a service interruption which may result from a cut or damaged cable, for example, in a wireline based communications environment.

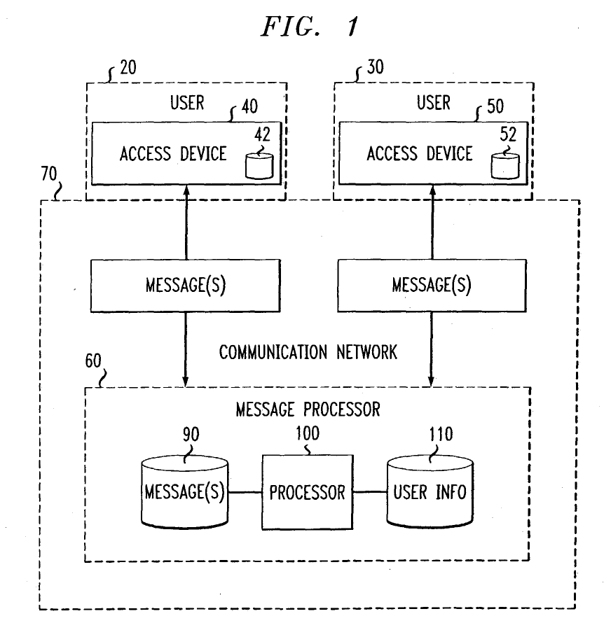

Referring to FIG. 1, a system 10 for providing communications recovery during service interruptions is shown. In the present embodiment, communications are exchanged via a variety of user devices such as wireless telephones but may also include laptops, personal digital assistants (PDAs), handhelds, PCs, pagers and other communication devices which allow individuals, groups and communities to communicate with one another from a variety of geographical locations. As used herein, the term “party”, “user” or “subscriber” may refer to an individual user, or may be used interchangeably to refer collectively to a group of users or a community of users.

Referring again to FIG. 1, in one exemplary basic configuration, system 10 includes one or more users 20, 30 utilizing one or more communication devices 40 and 50. Although only two exemplary users and their respective devices are illustrated in FIG. 1, it is contemplated that only one user or more than two users may have access to system 10 at any one time. It is also contemplated that multiple users may share a single device, or a single user may have multiple devices. Preferably, the system is used by a large multitude of users experiencing a large number of service interruptions. In one embodiment of the present invention, communication devices 40 and 50 include integrated message storage facilities 42 and 52 for receiving and storing messages during service interruptions, as discussed in more detail later herein. In operation, communication devices 40 and 50 are in communication with a message processor 60, which is accessible within a communication network 70. Message processor 60 may be integrated within one or more base stations, regional stations, central offices, and/or central stations present within communication network 70 and may be a standalone computer or a computing facility integrated within existing computing facilities within communication network 70. For example, in one embodiment, message processor 60 may be integrated with existing billing computers and related databases which track, manage and administer calls on an ongoing basis. In this manner, much of the information which is already captured related to the calls may be used to implement the teachings herein such as determining the telephone numbers of the parties involved in a call in order to re-establish communications between the parties after a service interruption has occurred.

In the present invention, communication network 70 generally provides interconnection utilizing various interconnection architectures including Internet Protocol (IP) based networks such as the Internet, the public switched telephone network (PSTN), ATM networks, signaling networks, wireless networks, satellite networks, fixed wireless networks, DSL networks as well as other systems. Communication network 70 provides versatile intelligent conduits that may carry, for example, Internet Protocol (IP) telephony or multimedia signals between the customer premises over, for example, the public switched telephone network, Internet, or wireless communication networks.

In the present invention, communications, such as between user access devices are enabled by variety of networks, protocols and standards including, but not limited to AMPS, NAMPS, TDMA, CDMA, GSM, TACS, ESMR, GPRS, Bluetooth, IEEE 802.11, infrared, TCP/IP, SMS, space-time coding and other related networks, protocols and standards. As used herein, the networks described herein may include base stations, regional stations, central stations and transmitters that are interconnected by landline trunks, base stations, satellites, antennas, routers, bridges and wireless connections to facilitate the necessary connections to establish the user communications.

Referring again to FIG. 1, in one embodiment of the present invention, communication devices 40, 50 may wireless telephones which are in communication with a series of base stations/access points within communication network 70. In the present invention, it is contemplated that a wide variety of technologies and methodologies can be utilized to provide the user wireless communications capability on a real-time basis. These may include systems for establishing wireless communications including various base stations, subscriber units, satellites, transmitters/receivers, etc.

Referring still to FIG. 1, in this exemplary embodiment, message processor 60 includes at least one message information database or storage facility 90, at least one general processor 100 and at least one user information database 110. Message processor 60 may also include Automatic Number Identification (ANI) facilities or other facilities for garnering call identification information as is well known to those skilled in the art.

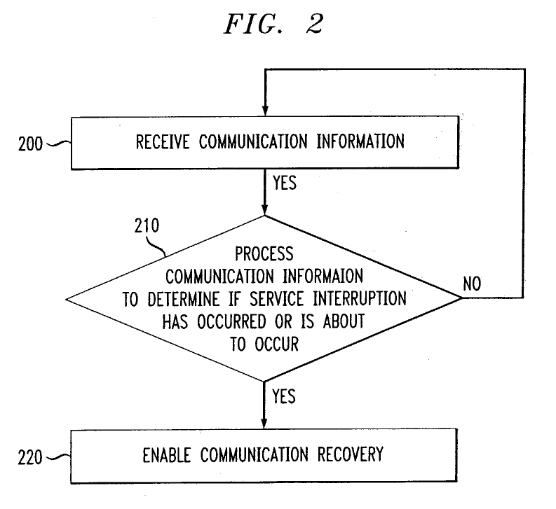

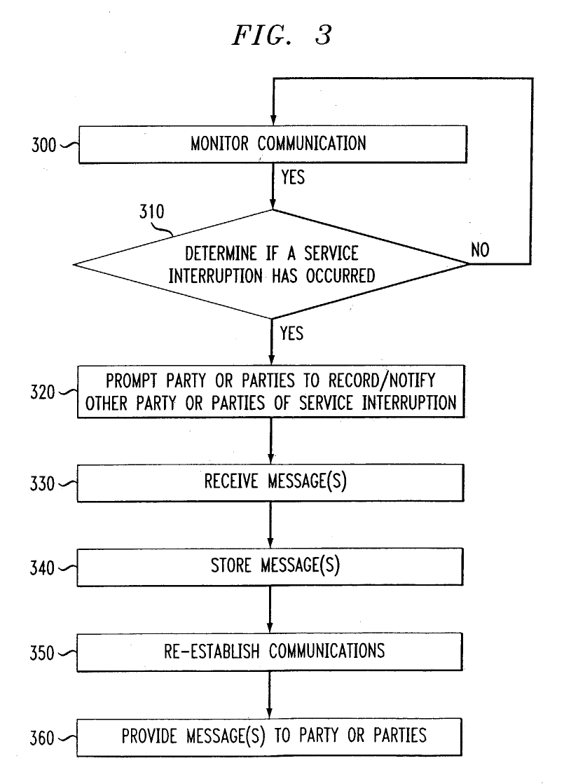

Referring to FIG. 2, there is shown an embodiment of the present method. In this embodiment, communication information is received, step 200. As discussed in more detail herein, the communication information may include date/time/location information related to a specific communication, the duration of the call, the location of the party originating the call and/or the location of the party receiving the call and also the actual content of the communication, such as may be extracted via an automatic speech recognition process. The received communication information is processed to determine if a service interruption has occurred or is about to occur, step 210. Processing will be discussed in more detail with reference to FIG. 3 later herein. If it is determined that a service interruption has occurred or is about to occur, the communication recovery process is enabled, step 220.

Referring to FIG. 3, another exemplary method in accordance with the present invention is shown. In this embodiment, one or more communications are monitored, step 300. Communications may be monitored via a message processor such as discussed earlier herein. During monitoring, it is determined if a service interruption has occurred, step 310. Service interruption may be determined in a number of manners such as the detection of an interruption of the communication or by a variety of other manners as known in the art. For example, communication monitoring may be performed by detecting certain signals which may indicate a service interruption such as an extended period of silence during a communication, whereby once a threshold of silence is reached, the communication can be presumed to be interrupted. Other factors may also be used in determining whether a service interruption has occurred such as the presence of static or signal noise, etc. Once a service interruption is detected, the party or parties are prompted to record a message(s) and in addition, one or more of the parties may be notified of the service interruption, step 320. For example, in a two party exchange, one party may be prompted to record a message and the other party may be notified as to the service interruption.

Alternatively, both parties may be prompted to record a message and/or notified of the service interruptions. In more than two party communications, a multitude of parties may be either prompted to record a message and notified of the service interruption or both as is necessary. Once the party or parties are prompted, one or more message(s) are received, step 330. In one embodiment, messages may be received and stored on the party's respective communication device and then later forwarded to a centralized message processor as discussed earlier herein. The one or more message(s) are stored, step 340, for example, on a centralized message processor. Communications may then later be re-established, step 350 and one or more message(s) are provided to one of the party or parties, step 360. In one embodiment, communications may be re-established by having the message processor re-establish a communication link between the parties and then playing the stored message(s) to one or more of the parties. The parties will be free to listen to the message(s) and then resume their conversation if necessary. In another embodiment, communication with the parties are re-established independently and one or more of the parties are provided the message(s). Each party is free then to re-establish a connection with the other party on their own time.

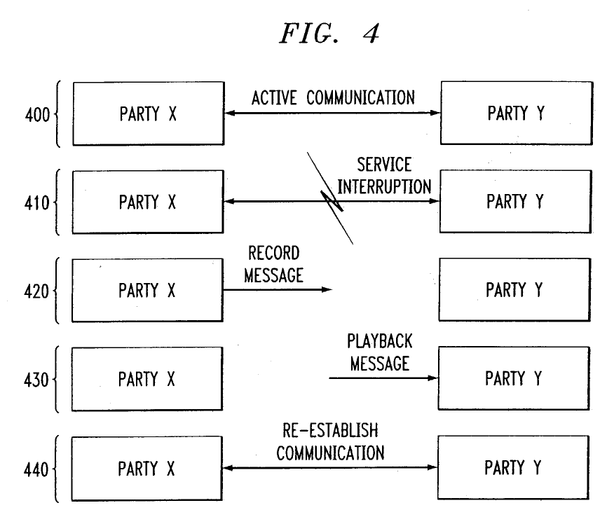

Referring to FIG. 4, a generalized diagrammatic representation of a typical communication flow contemplated by the present invention is shown. In a first stage of communications 400, two or more parties are involved in an active communication. In the next stage of communications 410, a service interruption is experienced by the parties. In the next stage of communications 420, one party, in this case, party X records a message intended for party Y. In the next stage of communications 430, the message party X recorded for party Y is played back for party Y. Finally, in the last stage of communications, the parties resume their communications.

By way of further example, the present invention operates as follows. One of more parties will be involved in a communication, such as a wireless telephone call which will experience a service interruption, such as one party heading into a geographical area with inadequate service coverage resulting in an interruption of service. When one party is talking on a cell or wireless phone or other similar device, if the call gets dropped, the cell phone will provide an indication as to the service interruption such as a beep or tone indicating service interruption while concurrently the other call participant receives an announcement explaining what happened. Upon hearing the tone or beep, the cell phone user can press a record button that allows the user to record a short voice message for the other person. Concurrently, the other call participant is offered an opportunity to leave a message for the cell phone user. As soon as the cell phone user enters a good cell, the cell phone beeps and at the user's request, the voice message left by the other call participant is played to the cell phone user. In the present invention, the voice message recorded by the cell phone user may be uploaded to the cellular network to a store-and-forward platform such as may exist within message processor 60. The store-and-forward platform can then call the former call participant and deliver the message. Also alternatively, the cell phone can place a call to the other call participant and if the call connect, the cell phone user can either talk to the called person or allow the recorded message to be played to the called person. The same type of service could be offered to a person on hold due to call waiting. Upon being placed on hold, they can be connected an announcement circuit that offers to connect the person on hold to a messaging service. If the person declines the offer, they continue to wait. If they accept the offer, they can leave a message that will be played to the call-waiting subscriber when the subscriber switches back to the first call.

While the present invention has been described with reference to preferred and exemplary embodiments, it will be understood by those of ordinary skill in the art that various changes may be made and equivalents may be substituted for elements thereof without departing from the scope of the invention. In addition, many modifications may be made to adapt a particular component or step to the teachings of the invention without departing from the scope thereof. For example, while the teachings here are discussed primarily with reference to wireless communications, the present inventive teachings may be easily applied to other types of communications, including wireline based communications and combinations of wireline and wireless communications. Therefore, it is intended that the invention not be limited to the particular embodiment disclosed, but that the invention will include all embodiments falling within the scope of the appended claims.

We claim:

1. A method comprising:
determining if a communication has been prematurely terminated between at least two parties;
recovering at least a portion of the communication if the communication has been prematurely terminated; and
re-establishing the prematurely terminated communication utilizing at least the recovered portion of the communication to re-establish the communication.

2. The method of claim 1, wherein determining if a communication has been prematurely terminated comprises detecting a wireless signal interruption.

3. The method of claim 1, wherein determining if a communication has been prematurely terminated comprises determining signal strength of the communication.

4. The method of claim 1, wherein recovering at least a portion of the communication if the communication has been prematurely terminated comprises recording a message from at least one of the parties in the communication.

5. The method of claim 1, wherein recovering at least a portion of the communication if the communication has been prematurely terminated comprises providing a message to at least one of the parties indicating that a signal interruption has occurred.

6. The method of claim 1, wherein recovering at least a portion of the communication if the communication has been prematurely terminated comprises recording a message from at least one of the parties and forwarding the message to a storage facility for later play back.

7. The method of claim 1, wherein recovering at least a portion of the communication comprises providing a facility for receiving a message from at least one of the parties.

8. The method of claim 1, wherein re-establishing the prematurely terminated communication utilizing at least the recovered portion of the communication comprises playing back a recorded message from at least of the parties to the other part(ies) in the communication.

9. The method of claim 8, wherein re-establishing the prematurely terminated communication utilizing at least the recovered portion of the communication comprises reconnecting the parties wherein each of the parties hears a recorded message recording by the other parties.

10. A method for recovering communications during service interruptions, the method comprising:
receiving a message from at least one party to a communication experiencing a service interruption;
recording the received message; and
providing the message to at least one other party which experienced the service interruption.

11. The method of claim 10 wherein receiving a message from at least one party to a communication experiencing a service interruption comprises providing a notification to the party that a service interruption has occurred.

12. The method of claim 10 wherein recording the received message comprises forwarding the message to a store and forward facility.

13. The method of claim 10 wherein providing the message to at least one other party which experienced the service interruption comprises re-establishing a communication between the parties.

14. The method of claim 10 further comprising:
re-establishing a communication between the parties.

15. The method of claim 10, wherein providing the message to at least one other party which experienced the service interruption comprises playing the message to the at least one other party.

16. The method of claim 10, further comprising calling back the at lest one other party which experienced the service interruption.

17. The method of claim 10, further comprising:
determining the onset of a service interruption.

18. A method comprising:
determining when a service interruption has occurred;
recording messages from users during service interruptions;
re-establishing communications between the users; and
playing back the messages received during service interruptions.

19. The method of claim 18 further comprising:
receiving messages from users during service interruptions.

20. The method of claim 18 wherein the service interruptions are wireless signal interruptions.
